(19) United States
(12) Patent Application Publication
(10) Pub. No.: US 2024/0399972 A1
(43) Pub. Date: Dec. 5, 2024

(54) Telescoping Bicycle Support Assembly

(71) Applicant: Yakima Products, Inc., Lake Oswego, OR (US)

(72) Inventors: Brandon Michael Willems, Portland, OR (US); Victor Truong, Portland, OR (US); Jason Attfield Sagen, Portland, OR (US)

(73) Assignee: Yakima Products, Inc., Lake Oswego, OR (US)

(21) Appl. No.: 18/679,165

(22) Filed: May 30, 2024

Related U.S. Application Data
(60) Provisional application No. 63/505,015, filed on May 30, 2023.

(51) Int. Cl. B60R 9/10; B60R 9/06

(52) U.S. Cl. CPC B60R 9/10; B60R 9/06

(57) ABSTRACT

A bicycle support assembly includes an outer tray structure and an inner tray structure, each supported on a frame structure, the inner tray having a proximal end slidably received in the outer tray. A first wheel retaining device is on a distal end of the outer tray, and a second wheel retaining device is on a distal end of the inner tray. The outer tray and the inner tray are each independently selectively securable to the frame structure at a plurality of positions.

### CROSS-REFERENCE TO RELATED APPLICATIONS

This application claims the benefit under 35 U.S.C. § 119 (e) of the priority of U.S. Provisional Patent Application Ser. No. 63/505,015, filed May 30, 2023, the entirety of which is hereby incorporated by reference for all purposes. The entirety of U.S. Patent Publication No. 2017/0349111 is also hereby incorporated by reference.

### BACKGROUND

Popularity of recreational outdoor activities is on the rise, with corresponding growth in the need to carry recreational equipment and cargo on vehicles. Hitch racks are particularly popular because the low loading level is easily accessible. Bicycles are one of the most common types of cargo routinely carried on vehicles, and the range of styles, sizes, and materials used in bicycle design continues to increase.

As a result, one of the problems a hitch rack must address is how to accommodate and secure multiple bicycles of different dimensions, without causing interference between adjacent features such as pedals, gears, and handlebars. There is a need for improved bicycle racks that are accessible, easy to use, and adaptable to carry numerous bicycles in a compact and secure arrangement.

### SUMMARY

The present disclosure provides systems, apparatus, and methods relating to telescoping bicycle support assemblies. In some examples, a bicycle support assembly may include an outer tray structure and an inner tray structure, each supported on a frame structure, the inner tray having a proximal end slidably received in the outer tray. A first wheel retaining device may be on a distal end of the outer tray, and a second wheel retaining device may be on a distal end of the inner tray. The outer tray and the inner tray may each be independently selectively securable to the frame structure at a plurality of positions.

In some examples, a bicycle rack may include a frame structure having a first beam portion, a second beam portion, and a lateral portion fixed to a hitch mount device and spanning between the first and second beam portions. The bicycle rack may further include a telescoping bicycle support assembly, having an outer tray fastened to first beam portion and an inner tray slidably received in the outer tray, with a first wheel support on a distal end of the outer tray and a second wheel support on a distal end of the inner tray. The inner tray may be selectively securable to the second beam portion within a continuous range of positions.

In some examples, a bicycle rack may include a frame structure having a first beam portion, a second beam portion, and a lateral portion fixed to a hitch mount device and spanning between the first and second beam portions. The bicycle rack may further include at least two telescoping bicycle support assemblies, each assembly spanning between the first and second beam portion. Each assembly may include an outer tray fastened to first beam portion and an inner tray slidably received in the outer tray, with a first wheel support on a distal end of the outer tray and a second wheel support on a distal end of the inner tray. The inner tray may be selectively securable to the second beam portion at a plurality of positions.

Features, functions, and advantages may be achieved independently in various examples of the present disclosure, or may be combined in yet other examples, further details of which can be seen with reference to the following description and drawings.

### BRIEF DESCRIPTION OF DRAWINGS

FIG. 1 is an isometric view of an illustrative hitch-mounted bicycle rack in accordance with aspects of the present disclosure, mounted on a vehicle and carrying two bicycles.

FIG. 2 is an isometric view of the rack of FIG. 1, with alternative bicycle tray assembly positions indicated in dashed lines.

FIG. 3 is a bottom plan view of the rack of FIG. 1, with the mast assembly omitted and the alternative bicycle tray assembly positions of FIG. 2 indicated in dashed lines.

FIG. 4 is an exploded view of a bicycle tray assembly of the rack of FIG. 1.

FIG. 5 is an exploded view of the frame and fastener assemblies of the rack of FIG. 1.

FIG. 6 is a side elevation view of the rack of FIG. 1, carrying two bicycles.

FIG. 7 is a side elevation view of an inner tray and an outer tray of the bicycle tray assembly of FIG. 4.

FIG. 8 is a cross-sectional view of the bicycle tray assemblies and the frame of the rack of FIG. 1, along line 8-8.

FIG. 9 is a cross-sectional view of the bicycle tray assemblies and the frame of the rack of FIG. 1, along line 9-9.

FIG. 10A is a first half of a cross-sectional view of a bicycle tray assemblies and the frame of the rack of FIG. 1, along line 10-10.

FIG. 10B is a second half of the cross-sectional view of a bicycle tray assembly and the frame of the rack of FIG. 1, along line 10-10.

### DETAILED DESCRIPTION

Various aspects and examples of a telescoping bicycle support assembly, as well as related bicycle carriers, and methods of supporting a bicycle on a carrier, are described below and illustrated in the associated drawings. Unless otherwise specified, a support assembly in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; (5) Advantages, Features, and Benefits; and (6) Conclusion.

### Definitions

The following definitions apply herein, unless otherwise indicated. Additionally, as used herein, like numerals refer to like parts.

“Substantially” means to be predominantly conforming to the particular dimension, range, shape, concept, or other aspect modified by the term, such that a feature or component need not conform exactly, so long as it is suitable for its intended purpose or function. For example, a “substantially cylindrical” object means that the object resembles a cylinder, but may have one or more deviations from a true cylinder.

“Approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of the specified value, insofar as such variations are appropriate to perform in the disclosure. It is to be understood that the value to which the modifier “approximately” refers is itself also specifically, and preferably, disclosed.

The terms “bicycle” and “bike” may are used interchangeably herein, and should be understood as equivalent. When used to describe a bicycle support assembly, carrier, or parts thereof, relative direction terms such as “proximal”, “distal”, “central”, “inboard”, “outboard”, “upper”, “lower”, “left”, or “right” may be understood in the context of a mounted position on a vehicle and a standard reference frame of a driver of the vehicle.

### Overview

In general, a telescoping bicycle support assembly in accordance with the present teachings may include an outer member and an inner member. A proximal end portion of the inner member may be at least partially received in a proximal end of the outer member. At the distal end of each member may be a wheel support and/or securing device, configured to receive a wheel of a bicycle.

One or both of the members may be able to float to accommodate a range of wheel sizes. That is, at least one member may be slidable or extensible relative to the other member to adjust a distance between the two wheel supports and/or an overall length of the support assembly.

The support assembly may also be referred to as a tray assembly or bicycle tray, and/or the inner and outer members may be referred to as trays. The inner and outer members may have matching or corresponding cross-sectional shapes, and/or the outer member may be shaped to receive the inner member. The cross-sectional size and shape may be consistent throughout a length of each member. In some examples, the inner and outer members may have a concave upper surface. In some examples, the inner and/or outer members may be rectangular or cylindrical.

One or both of the inner and outer members may be a hollow extrusion of a strong but lightweight material such as aluminum. Each wheel support may be integral to, molded on, adhesively bonded to, fastened to, or otherwise connected to the respective member. The wheel supports may be matching and symmetrical, at least partly asymmetrical, or of different shape and/or functional mechanism. For example, a wheel support may include a cup, tray, or ‘wheel taco’ style support portion. For another example, a wheel support may include a strap and buckle or a hook. In some examples, one or both of the wheel supports may be replaced by a bicycle fork support, to allow transport of a bicycle with a wheel removed.

A telescoping bicycle support assembly may include a frame structure, on which the outer member and the inner member are supported. The frame structure may also be referred to as a spine or support structure. In some examples, the frame structure may include a single elongate structural member. In some examples, the frame structure may include one or more pluralities of parallel elongate structural members, and/or may include rectangular or circular structures.

At least one of the outer and inner members may be supported on the frame structure, and secured to the frame structure. In examples where the frame structure includes multiple members or non-linear members, each of the outer and inner members may be supported on and secured to a separate portion of the frame structure.

One or both of the outer and inner members may be selectively securable to the frame structure in a plurality of positions. The member may be securable at a plurality of discrete positions, or within a continuous range of positions. For example, the member may be fastenable to each of a plurality of apertures in the frame structure or engagable with each of a plurality of fastener elements fixed to the frame structure. For another example, the member may be configured for clamping to the frame structure at any point within a section of the member.

In some examples, two or more telescoping bicycle support assemblies may include the same frame structure. That is, two assemblies may be described as sharing a frame, or as both supported on one frame.

In some examples, the support assembly may be part of a bike rack or bicycle carrier such as a tray-style hitch-mounted bicycle carrier. In general, a tray-style hitch-mounted bicycle carrier may include three main sub-assemblies: a hitch mount, a frame, and a plurality of tray assemblies. The tray assemblies may attach to the frame. The frame may attach to the hitch mount, which is configured to engage a hitch receiver on a vehicle. In some examples, a tray-style hitch-mounted bicycle carrier may further include other stabilizing or supporting structures and/or features. For instance, a mast may be mounted to the rack frame, to carry strap, clamps, or other engaging devices to stabilize a frame of a bicycle. A bicycle carrier in accordance with the present teachings may have at least one telescoping tray assembly.

### Examples, Components, and Alternatives

The following section describes selected aspects of an exemplary support assembly as well as related systems and methods. The section may include one or more distinct examples, and/or contextual or related information, function, and/or structure. The examples in this section are intended for illustration and should not be interpreted as limiting the entire scope of the present disclosure.

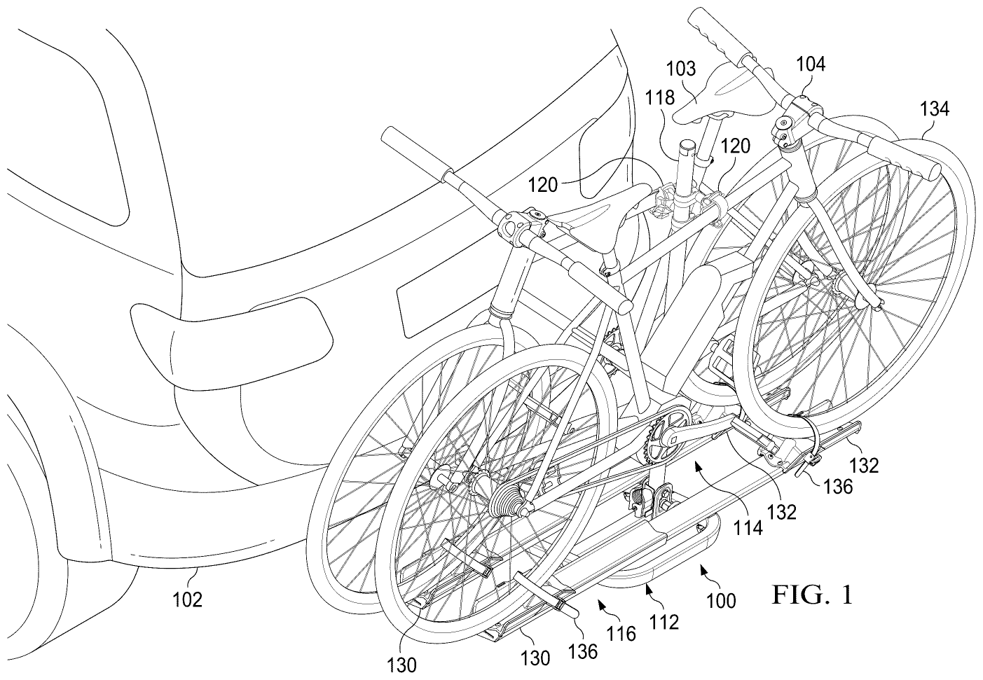

As shown in FIGS. 1-10, this section describes an illustrative hitch-mounted bike rack 100. Rack 100 includes a frame 112, on which are a proximal tray assembly 114 and a distal tray assembly 116, each of which is an example of a telescoping bicycle support assembly, as described above. In FIG. 1, rack 100 is depicted mounted to a vehicle 102, and supporting two bicycles 103, 104.

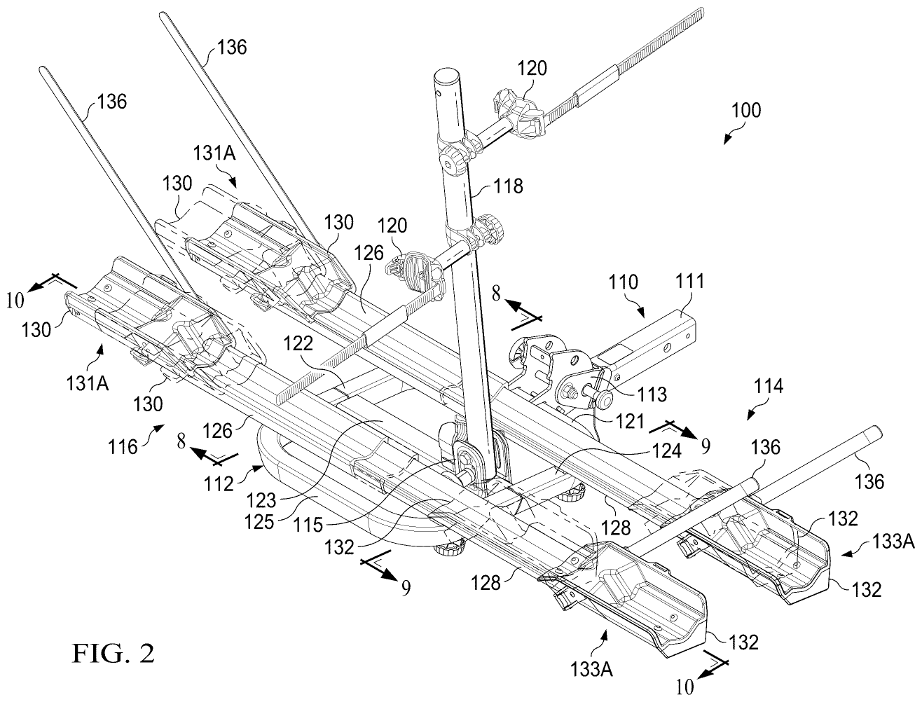

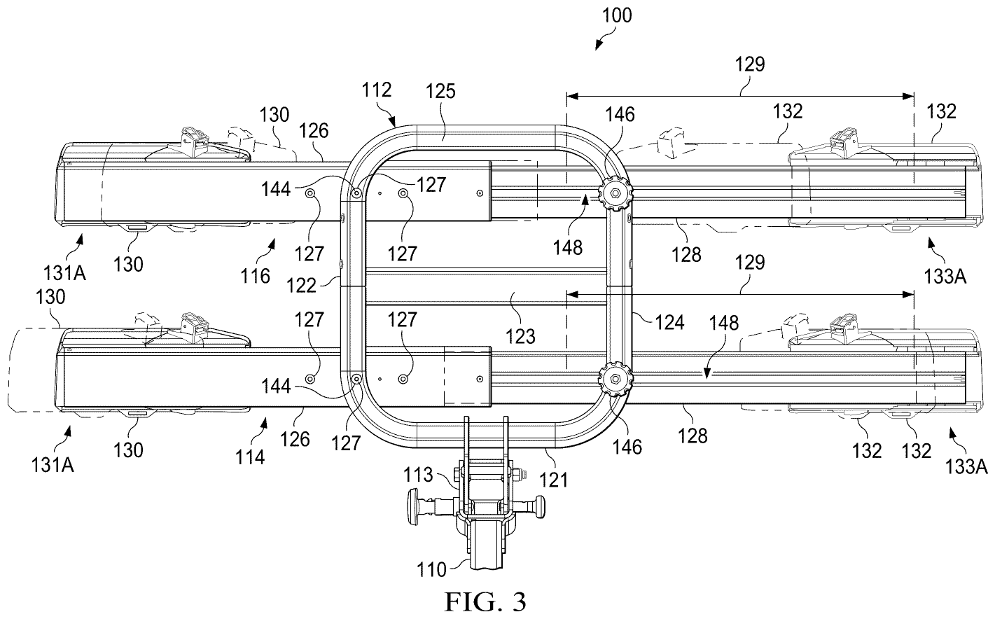

Each of tray assemblies 114, 116 includes a first wheel cup 130 and a second wheel cup 132. Each wheel cup includes a ratchet strap 136 and buckle, to secure a supported wheel in place. It should be noted that straps 136 are depicted in FIGS. 1-2, but omitted in FIGS. 3-4, 6, 8-10 for visual clarity.

In the present example, A mast 118 extends up from frame 112 and a pair of bicycle frame engaging assemblies 120 are adjustably clamped to the mast proximate an upper end. Each assembly may be adjusted into position to secure the frame of a bicycle supported on one of tray assemblies 114, 116. Any appropriate hooks, clamps, straps, or other methods of restraining the body or frame of a bicycle may be mounted to the mast or otherwise included in rack 100.

Bicycle 103 is supported by proximal tray assembly 114, with a front wheel strapped to first wheel cup 130 and a rear wheel strapped to second wheel cup 132. One of frame engaging assemblies 120 is strapped to a top tube of the frame of bicycle 103, securing the bicycle frame to mast 118. Similarly, bicycle 104 is supported by distal tray assembly 116, with a rear wheel strapped to first wheel cup 130 and a front wheel strapped to second wheel cup 132. The other of frame engaging assemblies is strapped to a top tube of bicycle 104.

In the present example, bicycle 103 is a standard un-powered bicycle and bicycle 104 is an electrically powered bicycle or e-bike. Tray assemblies 114, 116 may be constructed with sufficient strength to support the greater weight associated with e-bikes or other powered bicycles. In some examples, wheel cups 130, 132 may be configured to accommodate a range of tire widths and diameters associated with road bikes, mountain bikes, and powered bikes. In some examples, wheel cups 130, 132 may be adjustable or interchangeable with alternate wheel cups sized for a different range of tire sizes. In some examples, rack 100 may include a detachable ramp or other loading feature to assist in lifting powered bikes onto tray assemblies 114, 116.

As shown in FIG. 2, rack 100 includes a hitch mount device 110, with a stinger 111 to engage a vehicle hitch receiver and a pivoting assembly 113 fixed to frame 112. The pivoting assembly may allow the rack to move between positions on the vehicle, such as loading, transport, and/or stowed positions. In some examples, rack 100 may be fixedly mounted to the vehicle. In some examples, rack 100 may include additional adjustability and/or pivotable features. For instance, the rack may include a distal handle or foot pedal for actuation of pivoting assembly 113.

In FIGS. 1 and 2, rack 100 is shown in a transport position. Rack 100 may also have a stowed position, not depicted, in which frame 112 is approximately vertical and/or parallel a rear end of vehicle 102. To allow frame 112 to pivot up to the stowed position, mast 118 is pivotably mounted to the frame by assembly 115. Mast 118 is thereby collapsible to a position parallel tray assemblies 114, 116.

In the present example, frame 112 may be described as having a rounded rectangular or squared hoop shape, with a central bisecting member 123. A proximal lateral portion 121 is fixed to pivoting assembly 113 of hitch mount 110. A first beam portion 122 and a second beam portion 124 extend between proximal lateral portion 121 and a distal lateral portion 125. Lateral portions 121, 125 and bisecting member 123 may be described as spanning between first beam portion 122 and second beam portion 124.

The first and second beam portions are parallel to one another, and perpendicular to lateral members 121, 125 and bisecting member 123. The first and second beam portions and proximal and distal lateral portions may be described as four sides of the rounded rectangle of frame 112. The beam portions may also be referred to as beams, and the lateral portions as lateral members.

Proximal tray assembly 114 and distal tray assembly 116 are each supported between first beam 122 and second beam 124 of frame 112. The frame may additionally or alternatively include any structural elements appropriate to support tray assemblies 114, 116. In the present example, rack 100 includes two telescoping bicycle support assemblies. In some examples, rack 100 may include one, three, or any number of telescoping bicycle support assemblies, either alone or in addition to non-telescoping support assemblies. In some examples, one or more bicycle support assemblies may be supported on an optional extension for the frame of the rack.

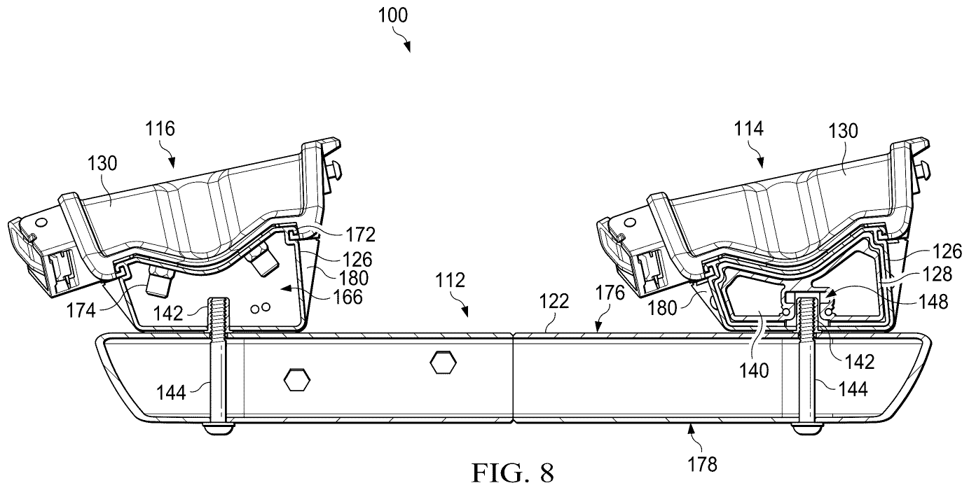

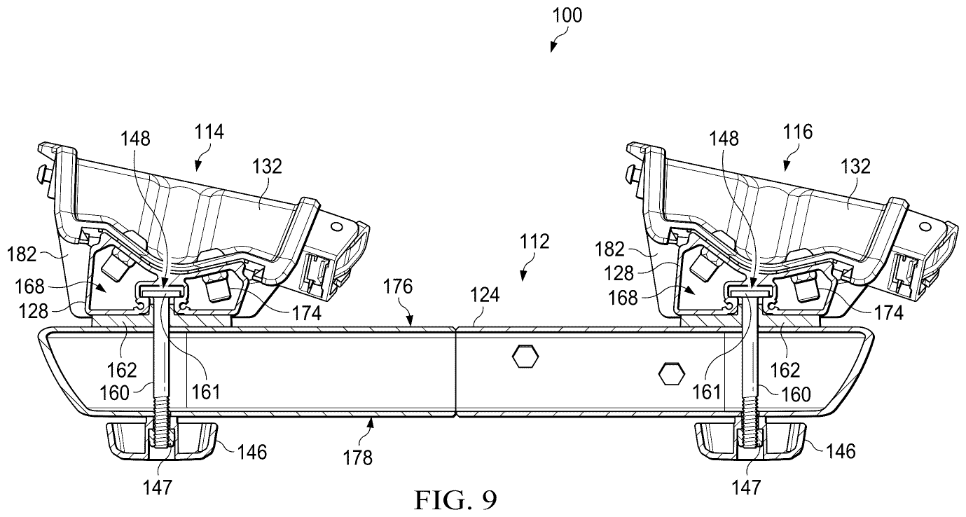

As discussed further with reference to FIGS. 8-9 below, in the present example, frame 112 has an approximately rectangular cross sectional shape, with a flared outer side and a flat upper surface. Frame 112 is hollow and comprised of front and back half sections welded together with bisecting member 123. In general, frame 112 may be of any effective shape, and unitary or comprised of multiple components welded, fastened, and/or otherwise fixed together.

In each of FIGS. 2 and 3, rack 100 is depicted in two possible configurations, with one configuration indicated in dashed outline. Rack 100 is adjustable between configurations by adjusting both a length and a lateral position of each of tray assemblies 114, 116. The length of the tray assembly may be adjusted to match a wheelbase of a supported bicycle, and the lateral position may be adjusted to avoid interference with a bicycle secured to the other tray assembly.

Each tray assembly includes an outer tubular member or outer tray 126 and an inner tubular member or inner tray 128. One end of inner tray 128 is received in outer tray 126, and the inner tray can slide into and out of the outer tray to adjust an overall length of tray assembly 116. The tray assembly may therefore be described as telescoping. More specifically, inner tray 128 and outer tray 126 can slide relative to one another to adjust a distance between first wheel cup 130 and second 132, to accommodate bikes of different sizes. In this example, the tray assembly can telescope to accommodate bikes that have wheel bases between approximately 33 inches and 54 inches.

In each tray assembly 114, 116, the outer tray 126 and inner tray 128 are each independently adjustable relative to frame 112, and are each independently secured to the frame. That is, outer tray 126 is fastened to first beam 122 and inner tray 128 is secured to second beam 124. The outer tray and inner tray are not directly fastened, pinned, clamped, or otherwise secured to one another. Nor does either tray assembly include means to secure the outer and inner trays directly to one another.

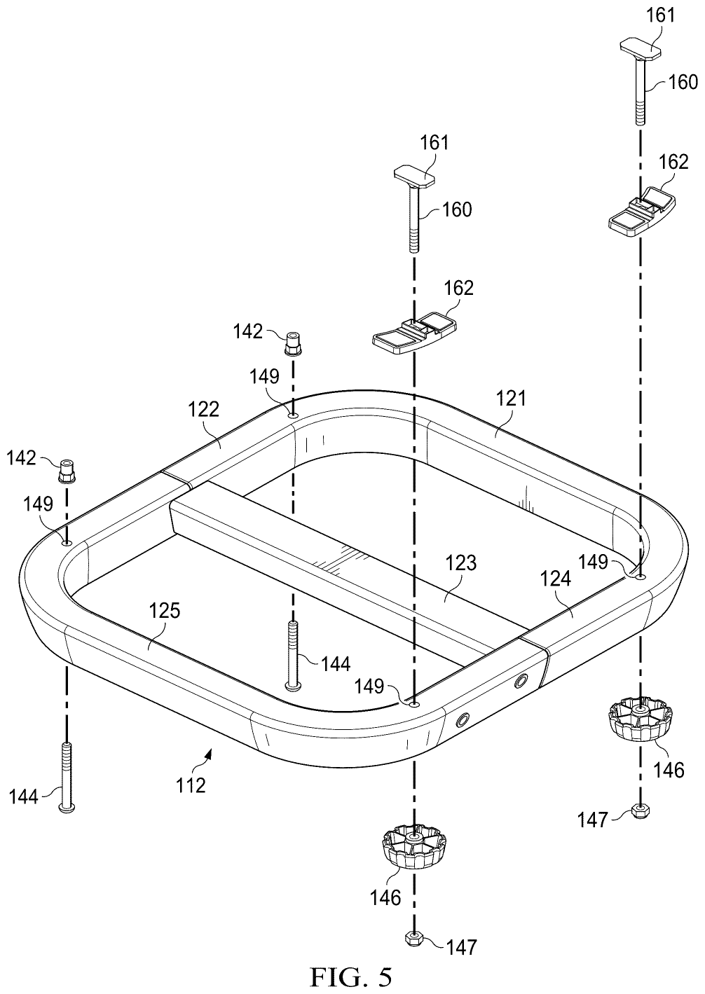

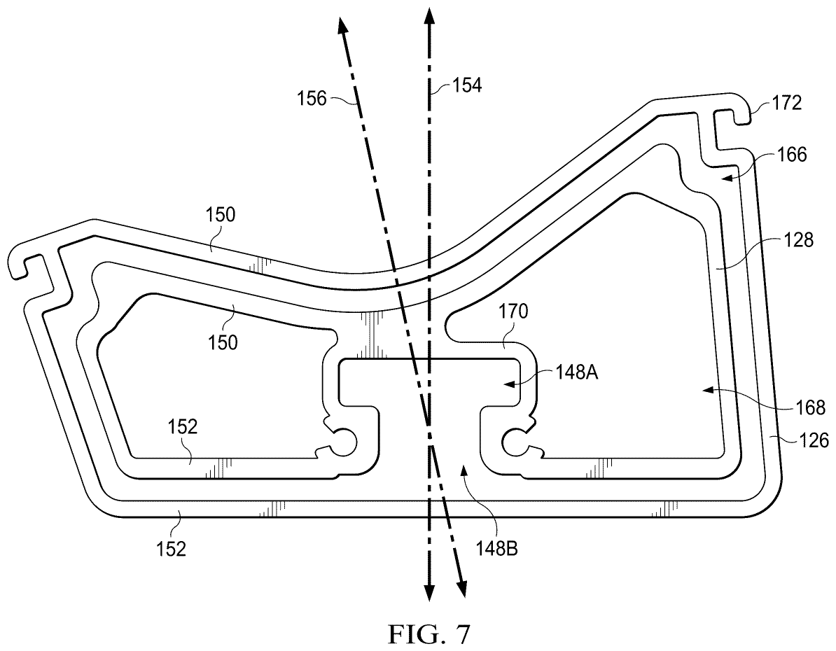

FIG. 3 depicts an underside of rack 100. Outer tray 126 of each tray assembly is fastened to first beam 122 of frame 112 by a bolt 144 extending through the beam into nuts in the bottom of the outer tray, as shown further in FIGS. 5, 9-10. Inner tray 128 of each tray assembly is secured to second beam 124. A T-bolt controlled by a knob 146 extends through the beam into a T-slot 148 formed in the bottom of the inner tray, as shown further in FIGS. 7-10. The knob can be hand-tightened or loosened to secure inner tray 128 in position, or allow the inner tray to slide.

In both FIGS. 2-3, outer tray 126 of proximal tray assembly 114 is depicted in a first position 131A and a second position 131B. Outer tray 126 of distal tray assembly 116 is also depicted in first position 131A, and in a third position 131C. In second position 131B, each outer tray 126 may be described as extended, or adjusted to the left. In third position 131C, each outer tray 126 may be described as retracted or adjusted to the right.

In the present example, outer trays 126 are only securable to first beam 122 in the depicted positions 131A, B, C. Each bolt 144 can engage the outer tray at a plurality of discrete positions 127. Specifically, each bolt 144 can engage one of three nuts of the corresponding outer tray.

In FIGS. 2-3, inner tray 128 of proximal tray assembly 114 is depicted in a first position 133A and a second position 133B. Inner tray 128 of distal tray assembly 116 is also depicted in first position 133A, and in a third position 133C. in second position 133B, each inner tray 128 may be described as extended, or adjusted to the right. In third position 133C, each inner tray 128 may be described as retracted, or adjusted to the left.

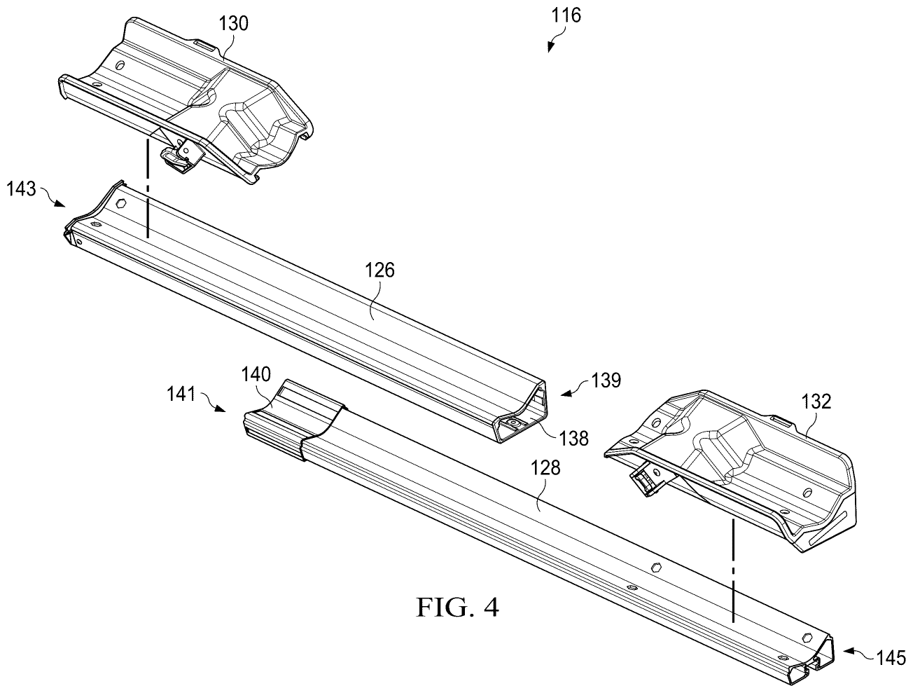

In the present example, inner trays 128 are securable to second beam 124 within a continuous range of positions 129. Within range 129, each inner tray 128 may be secured at any position. Engagement between elements of each tray assembly may define range 129 as described further with reference to FIG. 4, below.

In some examples, the proximal and distal tray assemblies may be differently adjustable. In some examples, the outer tray of any assembly may be securable at any position within a continuous range of positions and/or the inner tray may be securable only at a discrete plurality of positions. In some examples, the outer tray or the inner tray may be fixed and only one tray may be adjustable. In some examples, the tray assembly may include means to secure the inner and outer tray to one another, such as a clamp or pin.

FIG. 4 is an exploded view of the components of distal tray assembly 116. In the depicted example, the distal and proximal tray assemblies are substantially identical apart from their position in rack 100. Following description of either tray may therefore be understood to apply to both.

Outer tray 126 may be described as having a proximal end 139 and a distal end 143. Inner tray 128 may be similarly described as having a proximal end 141 and a distal end 145. When assembled in tray assembly 116, the proximal end of the inner tray is received in the proximal end of the outer tray. In the present example, outer tray 126 and inner tray 128 are both hollow and tubular, having an open interior space throughout the length of the tray. In some examples, inner tray 128 may be solid and/or either tray may include stiffening walls or other features obstructing some portion of the interior space.

The telescoping tray assembly includes a bushing 138 on proximal end 139 of outer tray 126, and a bushing 140 on proximal end 141 of inner tray 128. The bushings may facilitate smooth sliding between the inner and outer trays, and maintain correct alignment and spacing between the trays. In the present example, bushings 138, 140 are fastened to trays 126, 128. In some examples, the bushings may be bonded, over molded on, or otherwise fixed to the trays.

Bushing 138 extends into the proximal end of outer tray 126, with a flange exterior to the outer tray at proximal end 139. Bushing 138 may be described as tubular, or open at both ends. Bushing 140 surrounds the proximal end of inner tray 128, and extends over the proximal end to close the inner tray. That is, bushing 140 has a closed end and an open end, a wall of the closed end covering the open interior space of inner tray 128 at proximal end 141. The end wall of bushing 140 can be seen in FIG. 8, as described below. The end wall includes a slot or opening corresponding to the T-slot of inner tray 128, but with no crossbar section, such that the end wall blocks the T-bolt but allows passage of the three nuts of outer tray 126.

Bushing 138 may be shaped to closely conform to an outer surface of inner tray 128, and bushing 140 may be shaped to closely conform to an inner surface of outer tray 126. Bushings 138 and 140 may have a substantially similar cross-sectional shape.

Range 129 as depicted in FIG. 3, may be determined by contact between bushings 138, 140 and between wheel cup 132 and bushing 138. When assembled, bushing 140 on proximal end 141 of inner tray 128 may be entirely received in outer tray 126. Contact between inner ends of bushing 140 and bushing 138 may prevent complete withdrawal of inner tray 128 from outer tray 126. As inner tray 128 is received into outer tray 126, wheel cup 132 may contact the outer flange of bushing 138 and prevent further progress before bushing 140 reaches distal end 143 of the outer tray.

Wheel cup 130 is fastened to distal end 143 of outer tray 126, and wheel cup 132 is fastened to distal end 145 of inner tray 128, as discussed further with reference to FIGS. 8-9 below. Each wheel cup includes a raised portion against which the corresponding strap braces a bicycle's wheel, and a central channel to better accommodate narrower tires. As noted above, straps 136 shown in FIGS. 1-2 are omitted in FIGS. 3-4, 6, 8-10 for visual clarity.

FIG. 5 is an exploded view of frame 112 and the fastener elements that secure the proximal and distal tray assemblies to the frame. As shown, frame 112 includes four vertically extending apertures 149, two in first beam 122 and two in second beam 124. Each fastener element engages a corresponding aperture 149.

Each outer tray is secured to first beam 122 by one of bolts 144 extending through a corresponding one of apertures 149. Bolts 144 engage mounting rivet nuts 142, which are fixed into the bottom of the outer trays. One nut is shown in FIG. 5, but in the present example, the tray assembly includes three rivet nuts. In some examples, different fasteners or numbers of fasteners may be used.

Each inner tray is secured to second beam 124 by a T-bolt 160. One end of the T-bolt engages a nut 147, over which is molded one of knobs 146, to allow hand-tightening. At the other end, the ‘T’ of the bolt is trapped in the T-slot of the inner tray.

Each fastener assembly further includes a spacer 162 to support the inner tray on second beam 124, maintaining consistent height of the tray assembly relative to the frame and facilitating smooth sliding during telescoping adjustment. That is, spacer 162 may have a height corresponding to a gap between the inner tray and frame 112 that results from the size difference between the outer and inner tray. As knob 146 is tightened, T-bolt 160 clamps the inner tray and the second beam of the frame together, around the spacer.

In the present example, spacers includes a padding material on an upper surface. In some examples, the spacers may be configured to improve frictional contact with the inner tray and/or frame 112 for more secure clamping. In the present example, spacers 162 are asymmetrical to match the curved shape of frame 112, and include a raised central portion to extend into the T-slot of the inner tray and assist in centering and maintaining correct alignment of the inner tray. In general, the spacers may include and shape, feature, or material appropriate to supporting and aligning the inner tray.

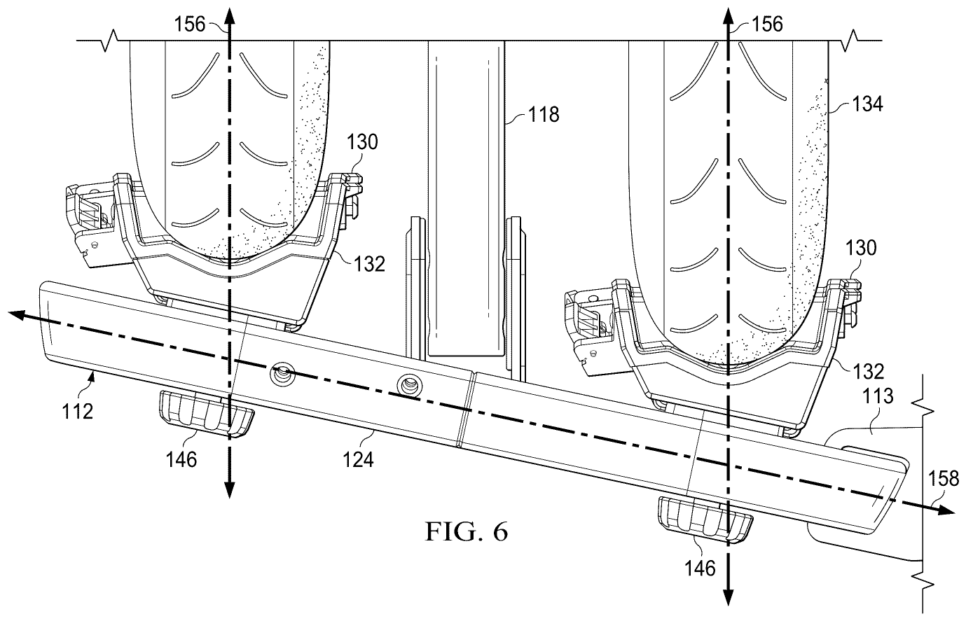

FIG. 6 is a partial side elevation view of rack 100. Frame 112 is pivoted to a transport position relative to the stinger of the hitch mount, with a primary plane 158 of the frame at an oblique angle to the horizontal. In this position, an axis of symmetry 156 of each tray assembly 114, 116 is approximately vertical. Axis of symmetry 156 is also parallel mast 118.

In this transport position, a bottom inner surface of each wheel cup may be described as approximately horizontal. As shown, wheels 134 of bicycles secured on rack 100 are vertical and also parallel to mast 118. However, the wheel on distal tray assembly 116 is higher than the wheel on proximal tray assembly 114. As a result, two supported bicycles may be vertically offset from one another, while remaining fully upright. Such an offset may help to avoid interference between projection portions of the bicycles such as pedals and handlebars.

FIG. 7 is an end-on view of outer tray 126 and inner tray 128 of one of the tray assemblies. Outer tray 126 and inner tray 128 are both hollow extrusions, which closely conform in cross-sectional shape. The trays each have an approximately quadrilateral shape, with two side walls, a concave upper wall 150, and a planar bottom wall 152. Outer tray 26 has a single interior space 166 in which inner tray 128 is received, and the inner tray has a divided interior space 168.

Bottom walls 152 of the trays may be described as defining a central axis 154 of the tray assembly, where the central axis is perpendicular to the planar walls. Outer tray 126 and inner tray 128 are both asymmetrical about central axis 154. One side wall is more angled relative to central axis 154, and shorter than the other side wall.

Concave upper wall 150 may be described as defining axis of symmetry 156, which forms an oblique angle with central axis 154. The upper wall may be shaped to conform to a wheel cup and support a bicycle in an upright position when rack 100 is in a transport position, as shown in FIG. 6.

Inner tray 128 is smaller than outer tray 126 and each wall of the inner tray is equidistantly spaced from the outer tray. The bushings described above with reference to FIG. 4, may maintain this spacing. At each corner where concave upper wall 150 meets a side wall, outer tray 126 includes a lip 172 partially enclosing a slot or recess. Lip 172 may engage a corresponding feature of wheel cup 130, as shown in FIG. 8 below. At where concave upper wall 150 meets a side wall, inner tray 128 includes an indent to avoid the recessed corners of the outer tray.

In general, outer tray 126 and inner tray 128 may have corresponding cross-sectional shapes, which may additionally or alternatively have other shapes, features and/or symmetries than those depicted in this example. In some examples, the outer and inner tray may deviate from matching cross-sectional shape with complementary protrusions and recesses to facilitate fit and reduce relative motion perpendicular to the direction of telescoping slide.

In some examples, rack 100 may be configured for transport of bicycles with the frame in a fully horizontal position. In such examples, the tray assemblies may be symmetrical and/or have a vertically aligned central axis.

Inner tray 128 further includes an interior wall 170, which creates T-slot 148 and divides inner space 168 of the inner tray into two sections. Interior wall 170 extends from planar bottom wall 152 to concave upper wall 150. The interior wall is joined to and/or unitary with each of the bottom and upper walls, which may improve structural strength of the inner tray. Where interior wall 170 meets planar bottom wall 152, the interior wall includes circular apertures to receive threaded fasteners, for fastening bushing 140 (FIG. 4) to inner tray 128.

T-slot 148 includes an upper crossbar section 148A and a lower vertical bar section 148B. As shown in FIG. 9 below, upper crossbar section 148A is configured to receive head 161 of one of T-bolts 160, and lower vertical bar section 148B is configured to receive the shaft of the bolt. However, the vertical bar section 148B is wider than the shaft of the T-bolt, to allow passage of rivet nuts 142 as shown in FIG. 8, below. Each rivet nut extends through a corresponding circular opening planar bottom wall 152 of outer tray 126, through lower vertical bar section 148B and into upper crossbar section 148A.

In some examples, other fasteners may be used to secure outer tray 126 and/or inner tray 128 to the rack frame. In such examples, inner tray 128 may include any slots, recesses, openings, and/or interior walls appropriate to engage the fasteners and allow sliding of the inner tray relative to outer tray 126.

In the present examples, no fasteners engage both outer tray 126 and inner tray 128 or join the outer and inner trays. In some examples, a tray assembly may include such a fastener. For instance, a tray assembly may include a collet pin that can be extended between one or more sets of alignable apertures in side walls of the outer and inner trays, as a backup or redundant safety mechanism.

FIG. 8 is a cross-sectional view of frame 112 and tray assemblies 114, 116 taken along line 8-8 of FIG. 2, when inner tray 128 of distal tray assembly 116 is in second position 133B. Hitch mount 110, mast 118, and straps 136 are omitted for simplicity. The cross section cuts through bolts 144, which fasten outer tray 126 of each assembly to first beam 122.

Each bolt 144 extends from under first beam 122 up into one of mounting rivet nuts 142 fixed in the bottom planar wall of the outer tray 126. In distal tray assembly 116, inner tray 128 is extended out and therefore not included in the cross section, while in proximal tray assembly 114, the inner tray is retracted and shown in cross section with T-slot 148 receiving the engaged mounting rivet nut 142. Inner tray 128 can thereby smoothly slide through the region where the outer tray is fastened to the first beam of the rack frame.

FIG. 9 is a cross-sectional view of frame 112 and tray assemblies 114, 116 taken along line 9-9 in FIG. 2, when inner tray 128 of proximal tray assembly 114 is in third position 133C. Hitch mount 110, mast 118, and straps 136 are omitted for simplicity. The cross-section cuts through T-bolts 160, which secure inner tray 128 of each assembly to second beam 124. In distal tray assembly 116, inner tray 128 is extended out and therefore wheel cup 132 is not cut in the cross section, while in proximal tray assembly 114, the inner tray is retracted and wheel cup 132 is cut through.

Each T-bolt 160 extends down from T-slot 148 of the inner tray 128. At one end, head 161 of the bolt is retained or trapped in the T-slot. At the other end, the T-bolt is threadedly engaged with nut 147. Hand wheel or knob 146 allows manual tightening or loosening of nut 147 on bolt 160, for adjustment of the inner tray without need for tools.

In the present example, each tray assembly further includes end caps for the trays. Specifically, as shown in FIG. 8 each outer tray 126 includes an end cap 180 and as shown in FIG. 9 each inner tray 128 includes an end cap 182. The end caps may occlude the openings into interior spaces 166, 168 at the distal ends of the other and inner trays, respectively.

Outer trays 126 and inner trays 128 may be described as supported on an upper side 176 of frame 112. The bottom planar wall of each outer tray 126 may directly contact the upper surface of the frame, while spacers 162 may be interposed between inner trays 128 and the frame. Both outer and inner trays may be described as supported on the upper side of frame 112. The bottom planar wall of each tray may be parallel to upper side 176 and to frame plane 158 (see FIG. 6).

Frame 112 is approximately rectangular in cross-section, with upper side 176 being generally planar. Side walls of the frame slope inward, to an opposing lower side 178 of the frame. Heads of bolts 144 and knobs 146 are disposed at lower side 148, accessible for adjustment of the rack by reaching under the rack. While mounted on a vehicle, frame 112 may be supported high enough off the ground as to leave sufficient clearance under the rack for access to bolts 144 and knobs 146.

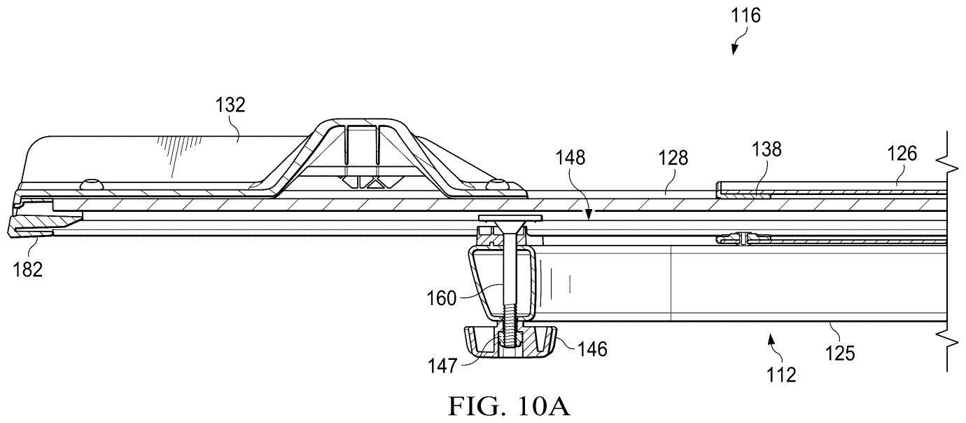

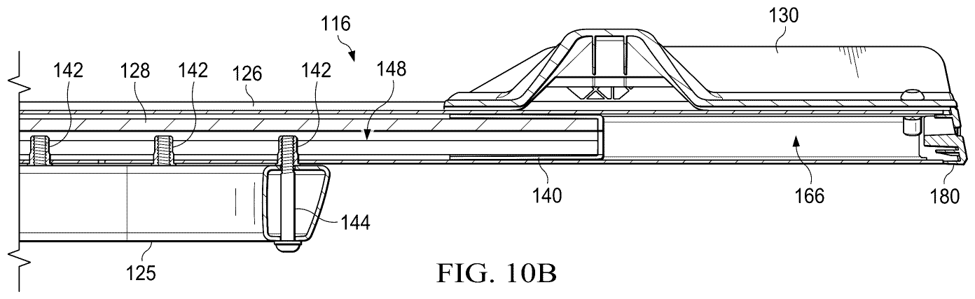

FIGS. 10A and 10B are left and right halves of a cross-sectional view of frame 112 and distal tray assembly 116 taken along line 10-10 in FIG. 2, when inner tray 128 is in third position 133C and outer tray 126 is in second position 131B. Hitch mount 110, mast 118, straps 136, and proximal tray assembly 114 are omitted for simplicity.

Each wheel cup includes a raised portion against which the corresponding strap braces a bicycle's wheel. The raised portion is proximate, but spaced from a proximal end of the wheel cup. A bicycle's wheel may be positioned distal of the raised portion, and urged inwardly by the strap. Apart from the raised portion, a bottom wall of each wheel cup is generally parallel the respective tray.

Wheel cup 130 is similar to, but not entirely symmetrical with wheel cup 132. As shown in FIGS. 8-9, each wheel cup 130, 132 is fastened to the outer or inner tray by at least two fastener assemblies 174. In the present example, the assembly includes a bolt and rivet. Wheel cup 132 includes a pair of fastener assemblies 174 proximal of and distal of the raised portion. Wheel cup 130 includes only one pair of fastener assemblies, proximate the distal end of outer tray 126.

Omitting the inner pair of fasteners may allow inner tray 128 to be received into outer 126 under wheel cup 130 without being obstructed by fasteners protruding into interior space 166. Instead of a fastening at a proximal end with a second pair of fastener assemblies, wheel cup 130 engages top corners of outer tray 126. Referring again to FIG. 8, wheel cup 130 includes an inwardly protruding hook-shaped section interlocking with lip 172 of the outer tray.

Wheel cups 130, 132 may include any features appropriate to securely engage the inner and outer trays and/or the wheel of a bicycle. The wheel cups may also be referred to as wheel supports, wheel retaining devices, or wheel tacos. In some examples, one or more of wheel cups 130, 132 on either or both tray assembly may be replaced by another support or device of any effective design.

### Illustrative Combinations and Additional Examples

This section describes additional aspects and features of telescoping bicycle support assemblies, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A0. A bicycle rack, comprising:
a hitch mount device;
a frame structure including a first beam portion, a second beam portion, and a lateral portion spanning between the first and second beam portions and fixed to the hitch mount device;
a telescoping bicycle support assembly, including:
   an outer tray fastened to the first beam portion,
   a first wheel support on a distal end of the outer tray,
   an inner tray slidably received in the outer tray, and
   a second wheel support on a distal end of the inner tray;
wherein the inner tray is selectively securable to the second beam portion within a continuous range of positions.
A1. The bicycle rack of A0, wherein the outer tray is selectively securable to the first beam portion at a plurality of discrete positions.
A2. The bicycle rack of A1, wherein:
the outer tray is securable by a plurality of fastener elements which extend into an interior of the outer tray, each fastener element defining one of the plurality of discrete positions, and
the inner tray includes a slot which receives the fastener elements as the inner tray is slidably received in the outer tray.
A3. The bicycle rack of A2, wherein the slot of the inner tray is a T-slot, and the inner tray is secured to the second beam portion by a t-bolt engaging the t-slot.
A4. The bicycle rack of any of A0-A3, wherein the inner tray is not directly fastened or clamped to the outer tray.
A5. The bicycle rack of any of A0-A4, wherein the outer tray and the inner tray are each hollow and tubular.
A6. The bicycle rack of A5, wherein the outer tray and the inner tray have corresponding generally quadrilateral cross sectional shapes, with a concave upper wall.
A7. The bicycle rack of A6, wherein the cross sectional shape of each of the outer tray and the inner tray is asymmetrical.
A8. The bicycle rack of A7, wherein the concave upper wall of each of the outer tray and the inner tray is approximately symmetrical.
A9. The bicycle rack of any of A6-A8, wherein the outer tray and the inner tray each have a planar bottom wall.
A10. The bicycle rack of A9, wherein the concave upper wall is asymmetrical relative to a central axis of the planar bottom wall.
A11. The bicycle rack of A9 or A10, wherein the outer tray and the inner tray each have first and second side walls which extend at an oblique, non-perpendicular angle relative to the planar bottom wall.
A12. The bicycle rack of A11, wherein for each of the outer tray and the inner tray, the first wall and the second wall extend at different angles relative to the planar bottom wall.
A13. The bicycle rack of any of A0-A12, wherein the first wheel support includes a trough with a ramped obstruction, and a strap assembly configured to brace a wheel against the ramped obstruction.
A14. The bicycle rack of A13, wherein the trough and the ramped obstruction include a recessed central channel.
A15. The bicycle rack of A14, wherein the first wheel support is fastened to the outer tray.
A16. The bicycle rack of A15, wherein the second wheel support includes a trough with a ramped obstruction, and a strap assembly configured to brace a wheel against the ramped obstruction.
A17. The bicycle rack of A16, wherein the trough and the ramped obstruction of the second wheel support include a recessed central channel.
A18. The bicycle rack of A17, wherein the second wheel support is fastened to the inner tray.
A19. The bicycle rack of any of A0-A18, wherein the telescoping bicycle support assembly is a first telescoping bicycle support assembly and further including a second telescoping bicycle support assembly, having:
an outer tray fastened to the first beam portion,
a first wheel support on a distal end of the outer tray,
   an inner tray slidably received in the outer tray, and
   a second wheel support on a distal end of the inner tray;
wherein the inner tray is selectively securable to the second beam portion within a continuous range of positions.
A20. The bicycle rack of any of A0-A19, wherein the lateral portion is a first lateral portion of the frame, and the frame includes second and third lateral portions, and further including a mast extending up from the second lateral portion, and a bike frame engaging assembly disposed on the mast.
A21. The bicycle rack of A20, wherein the mast is pivotable from a vertical use position to a horizontal stowed position.
B0. A bicycle support assembly, comprising:
a frame structure;
an outer tray supported on the frame structure;
a first wheel retaining device on a distal end of the outer tray;
an inner tray supported on the frame structure and having a proximal end slidably received in the outer tray; and
a second wheel retaining device on a distal end of the inner tray;
wherein the outer tray and the inner tray are each independently selectively securable to the frame structure at a plurality of positions.
B1. The support assembly of B0, wherein the outer tray is selectively securable to the frame structure at a plurality of discrete positions.
B2. The support assembly of B1, wherein the outer tray is securable by a plurality of fastener elements, each fastener element extending through a corresponding aperture in the frame structure and defining one of the plurality of discrete positions.
B3. The support assembly of B2, wherein the inner tray includes a T-slot, and the inner tray is secured to the frame structure by a t-bolt engaging the T-slot.
B4. The support assembly of B3, wherein the T-slot of the inner tray receives the fastener elements as the inner tray is slidably received in the outer tray.
B5. The support assembly of B4, wherein the fastener elements extend into an interior of the outer tray.
B6. The support assembly of any of B3-B5, wherein the outer tray and the inner tray are disposed on an upper side of the frame structure, and the fastener elements and the T-bolt are accessible at an opposing lower side of the frame structure.
B7. The support assembly of any of B0-B6, wherein the inner tray is not directly fastened or clamped to the outer tray.
B8. The support assembly of any of B0-B7, wherein the inner tray is selectively securable to the second beam portion within a continuous range of positions.
B9. The support assembly of any of B0-B8, wherein the outer tray and the inner tray are each hollow and tubular.
B10. The support assembly of B9, wherein the outer tray and the inner tray have corresponding asymmetrical cross sectional shapes, with a concave upper wall.
B11. The support assembly of B10, wherein the outer tray and the inner tray each have a planar bottom wall, and the concave upper wall is asymmetrical relative to a central axis of the planar bottom wall.
B12. The support assembly of any of B0-B11, wherein the first wheel retaining device is fastened to the outer tray, and the second wheel retaining device is fastened to the inner tray.
C0. A bicycle rack, comprising:
a hitch mount device;
a frame structure including a first beam portion, a second beam portion, and a lateral portion spanning between the first and second beam portions and fixed to the hitch mount device;
a telescoping bicycle support assembly, including:
an outer tray fastened to the first beam portion,
a first wheel support on a distal end of the outer tray,
   an inner tray slidably received in the outer tray, and
   a second wheel support on a distal end of the inner tray;
wherein the inner tray is selectively securable to the second beam portion within a continuous range of positions.
C1. The bicycle rack of C0, wherein the outer tray is selectively securable to the first beam portion at a plurality of discrete positions.
C2. The bicycle rack of C1, wherein the outer tray is securable by a plurality of fastener elements which extend into an interior of the outer tray, each fastener element defining one of the plurality of discrete positions.
C3. The bicycle rack of C2, wherein the inner tray includes a T-slot, and the inner tray is secured to the second beam portion by a t-bolt engaging the T-slot.
C4. The bicycle rack of C3, wherein the T-slot of the inner tray receives the fastener elements as the inner tray is slidably received in the outer tray.
C5. The bicycle rack of any of C0-C4, wherein the inner tray is not directly fastened or clamped to the outer tray.
C6. The bicycle rack of any of C0-C5, wherein the outer tray and the inner tray are each hollow and tubular.
C7. The bicycle rack of C6, wherein the outer tray and the inner tray have corresponding asymmetrical cross sectional shapes, with a concave upper wall.
C8. The bicycle rack of C7, wherein the outer tray and the inner tray each have a planar bottom wall, and the concave upper wall is asymmetrical relative to a central axis of the planar bottom wall.
C9. The bicycle rack of any of C0-C8, wherein the first wheel support is fastened to the outer tray, and the second wheel support is fastened to the inner tray.
C10. The bicycle rack of any of C0-C9, wherein the telescoping bicycle support assembly is a first telescoping bicycle support assembly and further including a second telescoping bicycle support assembly, having:
an outer tray fastened to the first beam portion,
a first wheel support on a distal end of the outer tray,
   an inner tray slidably received in the outer tray, and
   a second wheel support on a distal end of the inner tray;
wherein the inner tray is selectively securable to the second beam portion within a continuous range of positions.
C11. The bicycle rack of any of C0-C10, wherein the lateral portion is a first lateral portion of the frame, and the frame includes second and third lateral portions, and further including a mast extending up from the second lateral portion, and a bike frame engaging assembly disposed on the mast.
D0. A bicycle rack, comprising:
a hitch mount device;
a frame structure including a first beam portion, a second beam portion, and a lateral portion spanning between the first and second beam portions and fixed to the hitch mount device;
at least two telescoping bicycle support assemblies, each assembly spanning between the first and second beam portion and including:
   an outer tray fastened to the first beam portion,
   a first wheel support on a distal end of the outer tray,
   an inner tray slidably received in the outer tray, and
   a second wheel support on a distal end of the inner tray;
wherein the inner tray is selectively securable to the second beam portion at a plurality of positions.

### Advantages, Features, and Benefits

The different examples of the bicycle support assemblies and carriers described herein provide several advantages over known solutions for transporting bikes of various sizes and types. For example, illustrative examples described herein allow adjustment to accommodate bikes having a range of wheelbases.

Additionally, and among other benefits, illustrative examples described herein allow independent adjustment for each supported bike.

Additionally, and among other benefits, illustrative examples described herein allow adjustment through a continuous range of positions, to accommodate more than a standard set of sizes.

Additionally, and among other benefits, illustrative examples described herein allow overall lateral repositioning to offset and avoid interference between adjacent bikes.

Additionally, and among other benefits, illustrative examples described herein vertically offset support assemblies and avoid interference between adjacent bikes.

Additionally, and among other benefits, illustrative examples described herein allow manual adjustment, without need for tools.

Additionally, and among other benefits, illustrative examples described herein safely secure a bike through real world road conditions and vehicle operation.

No known system or device can perform these functions, particularly for the dimensions and higher weight of e-bikes. Thus, the illustrative examples described herein are particularly useful for carrying a bicycle of unusual dimensions and/or a variety of bicycles. However, not all examples described herein provide the same advantages or the same degree of advantage.

### CONCLUSION

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A bicycle support assembly, comprising:
a frame structure;
an outer tray supported on the frame structure;
a first wheel retaining device on a distal end of the outer tray;
an inner tray supported on the frame structure and having a proximal end slidably received in the outer tray; and
a second wheel retaining device on a distal end of the inner tray;
wherein the outer tray and the inner tray are each independently selectively securable to the frame structure at a plurality of positions.

2. The support assembly of claim 1, wherein the outer tray is selectively securable to the frame structure at a plurality of discrete positions.

3. The support assembly of claim 2, wherein the outer tray is securable by a plurality of fastener elements, each fastener element extending through a corresponding aperture in the frame structure and defining one of the plurality of discrete positions.

4. The support assembly of claim 3, wherein the inner tray includes a T-slot, and the inner tray is secured to the frame structure by a t-bolt engaging the T-slot.

5. The support assembly of claim 4, wherein the T-slot of the inner tray receives the fastener elements as the inner tray is slidably received in the outer tray.

6. The support assembly of claim 4, wherein the outer tray and the inner tray are disposed on an upper side of the frame structure, and the fastener elements and the T-bolt are accessible at an opposing lower side of the frame structure.

7. The support assembly of claim 1, wherein the inner tray is not directly fastened or clamped to the outer tray.

8. A bicycle rack, comprising:
a hitch mount device;
a frame structure including a first beam portion, a second beam portion, and a lateral portion spanning between the first and second beam portions and fixed to the hitch mount device;
a telescoping bicycle support assembly, including:
an outer tray fastened to the first beam portion,
a first wheel support on a distal end of the outer tray,
an inner tray slidably received in the outer tray, and
a second wheel support on a distal end of the inner tray;
wherein the inner tray is selectively securable to the second beam portion within a continuous range of positions.

9. The bicycle rack of claim 8, wherein the outer tray is selectively securable to the first beam portion at a plurality of discrete positions.

10. The bicycle rack of claim 9, wherein the outer tray is securable by a plurality of fastener elements which extend into an interior of the outer tray, each fastener element defining one of the plurality of discrete positions.

11. The bicycle rack of claim 10, wherein the inner tray includes a T-slot, and the inner tray is secured to the second beam portion by a t-bolt engaging the T-slot.

12. The bicycle rack of claim 11, wherein the T-slot of the inner tray receives the fastener elements as the inner tray is slidably received in the outer tray.

13. The bicycle rack of claim 8, wherein the inner tray is not directly fastened or clamped to the outer tray.

14. The bicycle rack of claim 8, wherein the outer tray and the inner tray are each hollow and tubular.

15. The bicycle rack of claim 14, wherein the outer tray and the inner tray have corresponding asymmetrical cross sectional shapes, with a concave upper wall.

16. The bicycle rack of claim 15, wherein the outer tray and the inner tray each have a planar bottom wall, and the concave upper wall is asymmetrical relative to a central axis of the planar bottom wall.

17. The bicycle rack of claim 8, wherein the first wheel support is fastened to the outer tray, and the second wheel support is fastened to the inner tray.

18. The bicycle rack of claim 8, wherein the telescoping bicycle support assembly is a first telescoping bicycle support assembly and further including a second telescoping bicycle support assembly, having:
an outer tray fastened to the first beam portion,
a first wheel support on a distal end of the outer tray,
an inner tray slidably received in the outer tray, and
a second wheel support on a distal end of the inner tray;
wherein the inner tray is selectively securable to the second beam portion within a continuous range of positions.

19. The bicycle rack of claim 8, wherein the lateral portion is a first lateral portion of the frame, and the frame includes second and third lateral portions, and further including a mast extending up from the second lateral portion, and a bike frame engaging assembly disposed on the mast.

20. A bicycle rack, comprising:
a hitch mount device;
a frame structure including a first beam portion, a second beam portion, and a lateral portion spanning between the first and second beam portions and fixed to the hitch mount device;
at least two telescoping bicycle support assemblies, each assembly spanning between the first and second beam portion and including:
an outer tray fastened to the first beam portion,
a first wheel support on a distal end of the outer tray,
an inner tray slidably received in the outer tray, and
a second wheel support on a distal end of the inner tray;
wherein the inner tray is selectively securable to the second beam portion at a plurality of positions.
